(19) United States
(12) Patent Application Publication
(10) Pub. No.: US 2010/0108351 A1
(43) Pub. Date: May 6, 2010

(54) FIRE RESISTANT CABLE

(75) Inventors: Paola Luciana Pinacci, Milano (IT); Franco Peruzzotti, Legnano (IT); Diego Tirelli, Sesto San Giovanni (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Pirelli & C.S.p.A.

(21) Appl. No.: 12/570,751

(22) Filed: Sep. 30, 2009

Related U.S. Application Data
(63) Continuation of application No. 10/512,996, filed on May 17, 2005, now abandoned.

(51) Int. Cl. H01B 3/10; B05D 5/12; C03C 8/14

(52) U.S. Cl. 174/110 A; 427/120; 501/17

(57) ABSTRACT

Cable comprising at least one conductor and at least a fire resistant coating layer including a composition comprising: (a) at least an organic polymer having a combustion temperature range comprised between a minimum value T1 and a maximum value T2; (b) at least a glass frit; (c) at least an inert compound; wherein:—said inert compound (c) has a softening point or a melting temperature of not less than 1000° C.;—said glass frit (b) reaches a viscosity of between 10⁷ poise and 10⁸ poise in a selected temperature range including the combustion temperature range of said organic polymer (a), said selected temperature range being such that said glass frit (b) flows over said inert compound (c) and the burned organic polymer (a) so as to form a solid char fire resistant coating layer.

### CROSS REFERENCE TO RELATED APPLICATIONS

This application is a continuation of U.S. application Ser. No. 10/512,996, filed May 17, 2005, which is a national phase application of international (PCT) Application No. PCT/WP02/04728, filed Apr. 29, 2002, the contents of all of which are incorporated herein by reference.

### BACKGROUND OF THE INVENTION

1. Field of the Invention

The present invention relates to a fire resistant cable.

More particularly, the present invention relates to a cable, in particular for the transmission or distribution of low-voltage or medium-voltage power or for telecommunications, or alternatively for data transmission, as well as to a mixed power/telecommunication cable, which is endowed with fire resistance properties.

Within the scope of the present invention, “low voltage” generally means a voltage up to 1 kV, whereas “medium voltage” means a voltage between 1 kV and 35 kV.

2. Description of the Related Art

Cables, in particular cables for the transmission or distribution of power, data, or telecommunication cables, signalling cables or control cables, which are capable of operating during a fire are more and more required in order to limit fire damages in buildings. Government regulations in various countries now specify that essential power circuits be protected in order to ensure the safety of persons inside the building and also to permit the firemen to be more efficient in controlling and extinguishing the fires.

In certain locations, such as high buildings, a minimum amount of time is needed so that all persons may be reached. Therefore, the electrical system during a fire must be able to be maintained operative at least during that amount of time. Consequently, said electrical system should maintain integrity and have continued conductivity performance during high temperatures that are associated with fire.

It has been established that some essential electrical circuits must be able to operate for at least 15 minutes or, in some cases, for three hours, or in other case for four hours in order to ensure the safety of the people. Such systems include, for example, alarms which are, in turn, essential in order to enable other systems to be operated, such as telephone systems, lighting systems, elevator systems, ventilation systems, fire pumps, smoke dectectors, ect.

In order to make fire resistant cables, it is known to use mica in insulating compositions. Having excellent dielectric properties and fire resistance, this natural material is well suited for use in electrical insulation applications.

For example, U.S. Pat. No. 2,656,290 discloses mica insulation provided in form of mica tapes. As described therein, individual mica flakes are bonded to one another, as well as to a pliable base sheet and, if desired, also a cover sheet, by a liquid bonding agent which may be hardened by suitable additives. The bonded mica tape used for these purposes may be relatively narrow, having a width of 2 cm to 3 cm for example, or it may be used in sheets of greater widht. A conductor is wrapped with the mica tape and the wrapped conductor is subjected to a vacuum and impregnated with a thin liquid impregnating resin. The resin and the bonding agent are specifically selected such that the bonding agent, together with the hardeners and the polymerization accelerators present in the impregnating resin, combine completely with the impregnating resin to form a uniform hardened insulative coating.

One of the drawbacks with such mica tapes as disclosed, for example, in U.S. Pat. No. 4,514,466, is that the vacuum impregnation step tends to be costly and care must be taken that the impregnating resin is fully dispersed throughout the windings to eliminate voids in the insulation which decrease the dielectric properties of the resulting insulation.

In addition to the drawbacks above disclosed, Applicant has observed that some problems could occur due to the detachment of the mica from the tape.

U.S. Pat. No. 5,227,586 discloses a flame resistant electric cable which is capable of resisting flame temperatures in the neighborhood of 1000° C. for at least two hours comprising: at least one electrical conductor consisting of an electrical wire, an extruded elongate tubular member made of silicone elastomer surrounding said electrical wire, an outer protective layer of braided inorganic material surrounding said tubular member, an overall outer braided jacket surrounding said electrical conductor.

WO 98/49693 discloses a ceramic fire resistant composition containing an organosilicon polymer, a ceramic filler such as, for example, Al₂O₃, and, additionally, a ceramic crystallizing mineral component whose melting temperature is lower than the sintering temperature of the ceramic filler. Said mineral component may be selected from mixtures of glass frits and glasses having low alcaline content and a melting point of less than 750° C. Said fire resistant composition is said to be particularly useful in the production of fire resistant cables, connecting boxes and distributor caps.

U.S. Pat. No. 5,173,960 discloses a fire retardant communications cable comprising a core which comprises at least one transmission media and fire retardant means which includes a material which comprises a mixture of a first inorganic oxide constituent and a second inorganic constituent and an organic base resin. The inorganic oxide constituents may be referred to as frits. Said fire retardant means may be included, for example, as the jacket of the cable, as longitudinally extending tape or may be co-extruded with the jacket. The first inorganic oxide constituent is characterized by melting when exposed to a temperatures as low as about 350° C., whereas the second inorganic constituent comprises a higher melting devitrifying frit which begins to crystallize at about 650° C. As a mixture of a first and of a second inorganic oxide a commercial product known under the tradename of Ceepree sold by Cepree Products Ltd is used. The organic base resin is selected from polyvinyl chloride, polyolefin, polyurethane and copolymer thereof. Said fire retardant means is said to be effective when the cable is exposed to temperatures in the range of about 350° C. to 1000° C.

WO 94/01492 discloses a fire retardant material in shaped form which retains its structural integrity after degradation of its organic content in a fire which is made by curing a shaped mass of curable elastomer (e.g. an ethylene/vinyl acetate copolymer) in which are dispersed (i) a mixture of glass-formers (“frits”) melting progressively over a range of several. hundred ° C. and containing components which devitrify in the upper part of the range, (ii) aluminum hydroxide and (iii) magnesium compound (e.g. Mg(OH)₂) endothermicallly decomposable to magnesium oxide. As the mixture of glass-formers (“frits”), a commercial product known under the tradename of Ceepree sold by Cepree Products Ltd is used. Said fire retardant material is said to be useful in a wide variety of situations such as, for example, as cable covering, as floor covering in transport vehicles, as a vertical fire barrier and as glazing beads for fire doors.

The Ceepree product is a powdered additive which may be used with composite formulations in the same way as most mineral fillers. It is a blend of vitreous/ceramic materials of different chemical compositions which have a very broad, almost continuous, melting range. As disclosed in U.S. Pat. No. 5,173,960 above cited, additional informations on Cepree product may be found, for example, in a paper authored by A. S. Piers and entitled “Enhanced Performance of Composite Materials under Fire conditions” presented at Polymers in a Marine Environment conference held in London on Oct. 23-24, 1991. Such a product is described also in a paper presented in Vol. 11 of “Proceedings of the Second Conference on Recent Advances in Flame Retardancy of Polymeric Materials” held on May 14-16, 1991, and edited by M. Levin and G. S. Kirshenbaum, copyright 1991 by Buruss Communications Co., Inc.

On the basis of Applicant's experience, the use of silicone elastomer compositions have some drawbacks. For example, the silicone elastomer compositions, even after crosslinking, show a poor mechanical properties. Moreover, the silicone elastomers usually used are costly and this negatively affect the cost of the final cable.

The Applicant has also found that the use of the mixtures such as those disclosed in U.S. Pat. No. 5,173,960 and in patent application WO 94/01492, does not provide sufficient fire resistance, particularly under severe fire conditions. In particular, the Applicant has found that, for the purpose of obtaining a cable endowed with improved fire resistance properties, the polymer material and the inorganic compounds have to be combined in a specific manner.

### SUMMARY OF THE INVENTION

The Applicant has now found that it is possible to improve said fire resistance properties by making a cable that is provided with at least one coating layer including a composition comprising at least an organic polymer, at least a glass frit and at least an inert compound, wherein the glass frit has a softening point which enables said glass frit to flow while said organic polymer is burning. In such a way, said glass frit flows over the ashes of said organic polymer and said inert compound so forming a solid char.

In a first aspect, the present invention relates to a cable comprising at least one conductor and at least a fire resistant coating layer including a composition comprising:
(a) at least an organic polymer having a combustion temperature range comprised between a minimum value T₁ and a maximum value T₂;
(b) at least a glass frit;
(e) at least an inert compound;
   wherein:
   said inert compound (c) has a softening point or a melting temperature of not less than 1000° C.;
   said glass frit (b) reaches a viscosity of between 10⁷ poise and 10⁸ poise in a selected temperature range including the combustion temperature range of said organic polymer (a), said selected temperature range being such that said glass frit (b) flows over said inert compound (c) and the burned organic polymer (a) so as to form a solid char fire resistant coating layer.

In a second aspect the present invention relates to a cable comprising at least one conductor and at least a fire resistant coating layer including a composition comprising:
(a) at least an organic polymer having a combustion temperature range comprised between a minimum value T₁ and a maximum value T₂;
(b) at least a glass frit;
(c) at least an inert compound;
   wherein:
   said inert compound (c) has a softening point or a melting temperature of not less than 1000° C.;
   said glass frit (b) reaches a viscosity of between 10⁷ poise and 10⁸ poise in a temperature range comprised between T₁−100° C. and T₂+100° C.

Preferably, said glass frit (b) reaches a viscosity of between 10⁷ poise and 10⁸ poise at a temperature higher than about 250° C., more preferably in a temperature range comprised between about 250° C. and about 450° C.

In the present description and in the subsequent claims, the term “conductor” means a conducting element of elongated shape and preferably of a metallic material, possibly coated with a semiconducting layer.

According to a first embodiment, the fire resistant coating layer is directly in contact with the conductor.

According to another embodiment, the cable has an electrically insulating inner layer and the fire resistant coating layer is placed radially external to said electrically insulating inner layer.

In a preferred embodiment, said fire resistant coating layer is directly in contact with said electrically insulating inner layer.

In another preferred embodiment, said fire resistant coating layer placed radially external to said electrically insulating inner layer is the outermost layer of the cable.

In a third aspect, the present invention relates to a composition comprising:
(a) at least an organic polymer having a combustion temperature range comprised between a minimum value T₁ and a maximum value T₂;
(b) at least a glass frit;
(c) at least an inert compound;
   wherein:
   said inert compound (c) has a softening point or a melting temperature of not less than 1000° C.;
   said glass frit (b) reaches a viscosity of between 10⁷ poise and 10⁸ poise in a temperature range comprised between T₁−100° C. and T₂+100° C.

Preferably, said glass frit (b) reaches a viscosity of between 10⁷ poise and 10⁸ poise at a temperature higher than 250° C., more preferably in a temperature range comprised between about 250° C. and about 450° C.

In a further aspect, the present invention relates to a method for preserving insulation capability in a cable under fire conditions which comprises forming a solid char structure by causing at least a glass frit (b) to flow over at least an inert compound (c) and at least a burned organic polymer (a).

Said causing at least a glass frit (b) to flows, includes selecting a glass frit (b) which is able to reach a viscosity of between 10⁷ poise and 10⁸ poise at a temperature in a range of temperatures which includes the combustion temperature range of the organic polymer (a).

With regard to said an organic polymer (a) the combustion temperature range may be determined by thermalgravimetric analysis (TGA) by means of, for example, a Perkin Elmer Pyris 1 TGA thermal analyzer, using the weight loss of the organic polymer on heating up to the complete combustion at rate of 10° C./min.

With regard to said glass fit (b) the viscosity range may be determined according to ASTM standard C338. According to said standard, said viscosity is reached at a temperature which corresponds to the softening point of said glass fit (b).

With regard to said inert compound (c), the softening point may be determined according to ASTM standard C388 while the melting temperature may be determined by means of a hot stage microscope (HMS), for example, by means of a microscope from Expert System, Mod. “Misura”. Said hot stage microscope technique allows to record the morphological changes occurring to a specimen at increasing temperature: more details may be found, for example, in “Industrial Ceramics”, Vol. 17 (2), 1997, pag. 69-73.

According to a preferred embodiment, the organic polymer (a) may be selected from: polyolefins, copolymers of different olefins, copolymers of olefins with esters having at least one ethylene unsaturation, polyesters, polyethers, copolymers polyether/polyester, and mixtures thereof.

Specific examples of organic polymers (a) which may be used in the present invention are: high density polyethylene (HDPE) (d=0.940-0.970 g/cm³), medium density polyethylene (MDPE) (d=0.926-0.940 g/cm³), low density polyethylene (LDPE) (d=0.910-0.926 g/cm³); copolymers of ethylene with α-olefins having from 3 to 12 carbon atoms (for example, 1-butene, 1-hexene, 1-octene) such as, for example, linear low density polyethylene (LLDPE) and ultra low density polyethylene (ULDPE) (d=0.860-0.910 g/cm³); polypropylene (PP); thermoplastic copolymers of propylene with another olefin, particularly ethylene; copolymer of ethylene with at least an ester selected from alkylacrylates, alkylmetacrylates and vinylcarboxylates, wherein the alkyl group, whether linear or branched, may have from 1 to 8, preferably from 1 to 4, carbon atoms, whereas the carboxyl group, whether linear or branched, may have from 2 to 8, preferably from 2 to 5, carbon atoms, such as, for example, ethylene vinyl/acetate copolymer (EVA), ethylene/ethylacrylate copolymer (EEA), ethylene/butylacrylate copolymer (EBA); elastomeric copolymers ethylene/α-olefins such as, for example, ethylene/propylene copolymer (EPR), ethylene/propylene/diene terpolymer (EPDM); halogenated polymers such as polyvinyl chloride; and mixtures thereof. Ethylene/vinyl acetate copolymer (EVA) is particularly preferred.

According to another preferred embodiment, the organic polymer (a) may be selected from copolymers of ethylene with at least one aliphatic α-olefin, and optionally a polyene, said copolymers being characterized by a molecular weight distribution (MDW) index of less than 5, preferably between 1.5 and 3.5. Preferably, said copolymers of ethylene with one aliphatic α-olefin, have a melting enthalpy (ΔHₘ) of not less than 30 J/g, more preferably between 34 J/g and 130 J/g.

The said molecular weight distribution index is defined as the ratio between the weight-average molecular weight (M_{w}) and the number-average molecular weight (Mₙ) and may be determined, according to conventional techniques, by gel permeation chromatography (GPC).

The said melting enthalpy (ΔHₘ) may be determined by Differential Scanning Calorimetry and relates to the melting peaks detected in the temperature range from 0° C. to 200° C.

With reference to the above copolymer of ethylene with at least one aliphatic α-olefin, the term “aliphatic α-olefin” generally means an olefin of formula CH₂═CH—R, in which R represents a linear or branched alkyl group containing from 1 to 12 carbon atoms. Preferably, the aliphatic α-olefin is chosen from propylene, 1-butene, isobutylene, 1-pentene, 4-methyl-1-pentene, 1-hexene, 1-octene, 1-dodecene, or mixtures thereof. 1-octene is particularly preferred.

With reference to the above copolymer of ethylene with at least one aliphatic α-olefin, the term “polyene” generally means a conjugated or non-conjugated diene, triene or tetraene. When a diene comonomer is present, this comonomer generally contains from 4 to 20 carbon atoms and is preferably chosen from: linear conjugated or non-conjugated diolefins such as, for example, 1,3-butadiene, 1,4-hexadiene, 1,6-octadiene, and the like; monocyclic or polycyclic dienes such as, for example, 1,4-cyclohexadiene, 5-ethylidene-2-norbornene, 5-methylene-2-norbornene, vinylnorbornene, or mixtures thereof. When a triene or tetraene comonomer is present, this comonomer generally contains from 9 to 30 carbon atoms and is preferably chosen from trienes or tetraenes containing a vinyl group in the molecule or a 5-norbornen-2-yl group in the molecule. Specific examples of triene or tetraene comonomers which may be used in the present invention are: 6,10-dimethyl-1,5,9-undecatriene, 5,9-dimethyl-1,4,8-decatriene, 6,9-dimethyl-1,5,8-decatriene, 6,8,9-trimethyl-1,6,8-decatriene, 6,10,14-trimethyl-1,5,9,13-pentadecatetraene, or mixtures thereof. Preferably, the polyene is a diene.

According to another preferred embodiment, the above copolymer of ethylene with at least one aliphatic α-olefin is characterized by:
a density of between 0.86 g/cm³ and 0.93 g/cm³, preferably between 0.86 g/cm³ and 0.89 g/cm³;
a Melt Flow Index (MFI), measured according to ASTM standard D1238-00, of between 0.1 g/10 min and 35 g/10 min, preferably between 0.5 g/10 min and 20 g/10 min; a melting point (Tₘ) of not less than 30° C., preferably between 50° C. and 120° C., even more preferably between 55° C. and 110° C.

The above copolymer of ethylene with at least one aliphatic α-olefin generally has the following composition: 50 mol %-98 mol %, preferably 60 mol %-93 mol %, of ethylene; 2 mol %-50 mol %, preferably 7 mol %-40 mol %, of an aliphatic α-olefin; 0 mol %-5 mol %, preferably 0 mol %-2 mol %, of a polyene.

According to a further preferred embodiment, the above copolymer of ethylene with at least one aliphatic α-olefin is characterized by a high regioregularity in the sequence of monomer units. In particular, said copolymer has an amount of —CH₂— groups in —(CH₂)ₙ— sequences, where n is an even integer, generally of less than 5 mol %, preferably less than 3 mol %, even more preferably less than 1 mol %, relative to the total amount of —CH₂— groups. The amount of —(CH₂)ₙ— sequences may be determined according to conventional techniques, by ¹³C-NMR analysis.

According to a further preferred embodiment, the above copolymer of ethylene with at least one aliphatic α-olefin is characterized by a composition distribution index of greater than 45%, said index being defined as the weight percentage of copolymer molecules having an α-olefin content within to 50% of the average total molar content of α-olefin.

The composition distribution index gives a measure of the distribution of the aliphatic α-olefin among the copolymer molecules, and may be determined by means of Temperature Rising Elution Fractionation Techniques, as described, for example, in U.S. Pat. No. 5,008,204, or by Wild et al. in J. Poly. Sci. Poly, Phys. Ed., Vol. 20, p. 441 (1982).

The above copolymer of ethylene with at least one aliphatic α-olefin may be obtained by copolymerization of ethylene with at least an aliphatic α-olefin, in the presence of a single-site catalyst such as, for example, a metallocene catalyst or of a so-called “Constrained Geometry Catalyst”.

Metallocene catalysts which may be used in the polymerization of olefins are, for example, coordination complexes between a transition metal, usually from group IV, in particular titanium, zirconium or hafnium, and two optionally substituted cyclopentadienyl ligands, which are used in combination with a co-catalyst, for example an aluminoxane, preferably methylaluminoxane, or a boron compound (see, for example, Adv. Organomet. Chem, Vol. 18, p. 99, (1980); Adv. Organomet. Chem, Vol. 32, p. 325, (1991); J. M. S.—Rev. Macromol. Chem. Phys., Vol. C34(3), pp. 439-514, (1994); J. Organometallic Chemistry, Vol. 479, pp. 1-29, (1994); Angew. Chem. Int., Ed. Engl., Vol. 34, p. 1143, (1995); Prog. Polym. Sci., Vol. 20, p. 459 (1995); Adv. Polym. Sci., Vol. 127, p. 144, (1997); U.S. Pat. No. 5,229,478, or patent applications WO 93/19107, EP 35 342, EP 129 368, EP 277 003, EP 277 004, EP 632 065).

Catalysts so-called “Constrained Geometry Catalyst” which may be used in the polymerization of olefins are, for example, coordination complexes between a metal, usually from groups 3-10 or from the Lanthanide series, and a single, optionally substituted cyclopentadienyl ligand, which are used in combination with a co-catalyst, for example an aluminoxane, preferably methylaluminoxane, or a boron compound (see, for example, Organometallics, Vol. 16, p. 3649, (1997); J. Am. Chem. Soc., Vol. 118, p. 13021, (1996); J. Am. Chem. Soc., Vol. 118, p. 12451, (1996); J. Organometallic Chemistry, Vol. 482, p. 169, (1994); J. Am. Chem. Soc., Vol. 116, p. 4623, (1994); Organometallics, Vol. 9, p. 867, (1990); U.S. Pat. No. 5,096,867, U.S. Pat. No. 5,414,040, or patent applications WO 92/00333, WO 97/15583, WO 01/12708, EP 416 815, EP 418 044, EP 420 436, EP 514 828.

The synthesis of the above copolymers of ethylene with at least one aliphatic α-olefin in the presence of metallocene catalysts is described, for example, in patent application EP 206 794, or in Metallocene-based polyolefins, Vol. 1, Wiley series in Polymer Science, p. 309, (1999).

The synthesis of the above copolymers of ethylene with at least one aliphatic α-olefin in the presence of catalysts so-called “Constrained Geometry Catalyst” is described, for example, in Macromol. Chem. Rapid. Commun., Vol. 20, p. 214-218, (1999); Macromolecules, Vol. 31, p. 4724 (1998); Macromolecules Chem. Phys., Vol. 197, p. 4237 (1996); or in patent application WO 00/26268; or in U.S. Pat. No. 5,414,040.

Examples of copolymers of ethylene with at least one aliphatic α-olefin which may be used in the present invention and which are currently commercially available are the products Engage® from DuPont-Dow Elastomers and Exact® from Exxon Chemical.

According to another preferred embodiment, the organic polymer (a) may optionally contain functional groups selected from: carboxylic groups, anhydride groups, ester groups, silane groups, epoxy groups. The amount of functional groups present in the organic polymer (a) is generally comprised between 0.05 parts and 50 parts by weight, preferably between 0.1 parts and 10 parts by weight, based on 100 parts by weight of the organic polymer (a).

The functional groups may be introduced during the production of the organic polymer (a), by co-polymerization with corresponding functionalized monomers containing at least one ethylene unsaturation, or by subsequent modification of the organic polymer (a) by grafting said functionalized monomers in the presence of a free radical initiator (in particular, an organic peroxide).

Alternatively, it is possible to introduce the functional groups by reacting pre-existing groups of the organic polymer (a) with a suitable reagent, for instance by an epoxidation reaction of a diene polymer containing double bonds along the main chain and/or as side groups with a peracid (for instance, m-chloroperbenzoic acid or peracetic acid) or with hydrogen peroxide in the presence of a carboxylic acid or a derivative thereof.

Functionalized monomers which may be used include for instance: silanes containing at least one ethylene unsaturation; epoxy compounds containing at least one ethylene unsaturation; monocarboxylic or, preferably, dicarboxylic acids containing at least one ethylene unsaturation, or derivatives thereof, in particular anhydrides or esters.

Examples of silanes containing at least one ethylene unsaturation are: 3-aminopropyl-triethoxysilane, γ-methacryloxypropyltri-methoxysilane, allyltrimethoxysilane, allyltriethoxysilane, allyl-methyldimethoxysilane, allylmethyldiethoxysilane, methyltriethoxysilane, methyltris(2-methoxyethoxy)-silane, dimethyldiethoxysilane, vinyltris(2-methoxy-ethoxy)silane, vinyltrimethoxy-silane, vinylmethyl-dimethoxysilane, vinyltriethoxysilane, octyltriethoxy-silane, isobutyltrimethoxysilane, isobutyltriethoxy-silane, or mixtures thereof.

Examples of epoxy compounds containing at least one ethylene unsaturation are: glycidyl acrylate, glycidyl methacrylate, itaconic acid monoglycidyl ester, maleic acid glycidyl ester, vinylglycidyl ether, allylglycidyl ether, or mixtures thereof.

Examples of monocarboxylic or dicarboxylic acids containing at least one ethylene unsaturation are: maleic acid, maleic anhydride, fumaric acid, citraconic acid, itaconic acid, acrylic acid, methacrylic acid, and anhydrides or esters derived therefrom, or mixtures thereof. Maleic anhydride is particularly preferred.

Polyolefins grafted with maleic anhydride are available as commercial products identified, for instance, by the trademarks Fusabond® (Du Pont), Orevac® (Elf Atochem), Exxelor® (Exxon Chemical), Yparex® (DSM).

According to another preferred embodiment, the organic polymer (a) may be selected from thermosetting resins such as epoxy acrylates, polyurethane acrylates, acrylated polyesters, phenolic resins, or mixtures thereof.

According to a preferred embodiment, the glass frit (b) may be selected from inorganic oxide glasses.

Examples of inorganic oxide glasses which may be used in the present invention may be selected from:
phosphates glasses having the following mole percent composition: 1.2% to 3.5% of B₂O₃, 50% to 75% of P₂O₅, 0% to 30% of PbO and 0% to 5% of at least one oxide selected from the oxide of Cu, Ag, Au, Sc, Y, La, Ti, Zr, Hf, V, Nb, Ta, Cr, Mo, W, Mn, Tc, Re, Fe, Co, Ni, Ru, Rh, Pd, Os, Ir, Pt, Ce, Pr, Nd, Pm, Sm, Eu, Gd, Tb, Dy, Ho, Er, Tm, Yb, Lu, Th, Pd, and U, which glass includes at least one oxide selected from alkali metal oxides and at least one oxide selected from alkaline earth metal oxides and zinc oxide;
lead oxide glasses having the following mole percent composition: 1.2% to 3.5% of B₂O₃, 50% to 58% of P₂O₅, 10% to 30% of PbO and 0% to 5% of at least one oxide selected from the oxide of Cu, Ag, Au, Sc, Y, La, Ti, Zr, Hf, V, Nb, Ta, Cr, Mo, W, Mn, Tc, Re, Fe, Co, Ni, Ru, Rh, Pd, Os, Ir, Pt, Ce, Pr, Nd, Pm, Sm, Eu, Gd, Tb, Dy, Ho, Er, Tm, Yb, Lu, Th, Pd, and U, which glass includes at least one oxide selected from alkali metal oxides and at least one oxide selected from alkaline earth metal oxides and zinc oxide;
bismuth oxide glasses having the following mole percent composition: 1.2% to 20% of B₂O₃, 50% to 75% of Bi₂O₃, 10% to 30% of ZnO, and 0% to 5% of at least one oxide selected from the oxide of Pb, Fe, Si, Cu, Ag, Au, Sc, Y, La, Ti, Zr, Hf, V, Nb, Ta, Cr, Mo, W, Mn, Tc, Re, Fe, Co, Ni, Ru, Rh, Pd, Os, Ir, Pt, Ce, Pr, Nd, Pm, Sm, Eu, Gd, Tb, Dy, Ho, Er, Tm, Yb, Lu, Th, Pd, and U, which glass includes at least one oxide selected from alkali metal oxides and at least one oxide selected from alkaline earth metal oxides; borate oxide glasses having the following mole percent composition: 15% to 35% CaO, 35% to 55% B₂O₃, 10% to 35% SiO₂, 0% to 20% of at least one oxide selected from the oxide of: Mg, Sr, Ba, Li, P, Na, K, Al, Zr, Mo, W, Nb, and 0% to 8% of F.

The glass fit (b) may be added to the composition of the present invention in a quantity of between 1 part in volume to 50 parts in volume, preferably between 2 part in volume to 25 parts in volume, with respect to the total volume of the composition.

According to a preferred embodiment, the inert compound (c) may be selected from: silicates such as, for example, aluminum silicates (for example, kaolin optionally calcinated, mullite), magnesium silicates (for example, talc optionally calcined); hydroxides, hydrate oxides, salts or hydrated salt of metals, in particular of calcium, aluminium or magnesium such as, for example, magnesium hydroxide, aluminium hydroxide, alumina trihydrate, magnesium carbonate hydrate, magnesium carbonate, magnesium calcium carbonate hydrate, calcium carbonate, magnesium calcium carbonate; or mixtures thereof.

Said inert compound (c) may be advantageously used in the form of coated particles. Coating materials preferably used are saturated or unsaturated fatty acids containing from 8 to 24 carbon atoms and metal salts thereof such as, for example, oleic acid, palmitic acid, stearic acid, isostearic acid, lauric acid, magnesium or zinc stearate or oleate, or mixtures thereof.

To favour the compatibility between the inert compound (c) and the organic polymer (a), a coupling agent may be added to the mixture. Said coupling agent may be selected from: saturated silane compounds or silane compounds containing at least one ethylene unsaturation; epoxides containing at least one ethylene unsaturation; organic titanates; mono- or dicarboxylic acids containing at least one ethylene unsaturation, or derivatives thereof such as, for example, anhydrides or esters.

Examples of silanes containing at least one ethylene unsaturation are: 3-aminopropyl-triethoxysilane, γ-methacryloxypropyltrimethoxysilane, allyltrimethoxysilane, allyltriethoxysilane, allyl-methyldimethoxysilane, allylmethyldiethoxysilane, methyltriethoxysilane, methyltris(2-methoxyethoxy)-silane, dimethyldiethoxysilane, vinyltris(2-methoxy-ethoxy)silane, vinyltrimethoxysilane, vinylmethyl-dimethoxysilane, vinyltriethoxysilane, octyltriethoxy-silane, isobutyltrimethoxysilane, isobutyltriethoxy-silane, or mixtures thereof.

Examples of epoxy compounds containing at least one ethylene unsaturation are: glycidyl acrylate, glycidyl methacrylate, itaconic acid monoglycidyl ester, maleic acid glycidyl ester, vinylglycidyl ether, allylglycidyl ether, or mixtures thereof.

An example of organic titatanate is tetra-n-butyl titanate.

Examples of monocarboxylic or dicarboxylic acids containing at least one ethylene unsaturation are: maleic acid, maleic anhydride, fumaric acid, citraconic acid, itaconic acid, acrylic acid, methacrylic acid, and anhydrides or esters derived therefrom, or mixtures thereof. Maleic anhydride is particularly preferred.

The coupling agent may be used as such or may be already present onto the organic polymer (a) which has been functionalized as disclosed above.

Alternatively, the coupling agents of carboxylic or epoxy type mentioned above (for example, maleic anhydride) or silanes containing an ethylene unsaturation (for example, vinyltrimethoxysilane) may be added to the composition in combination with a radical initiator so as to graft the compatibilizing agent directly onto the organic polymer (a). Initiators which may be used are, for example, organic peroxides such as, for example, t-butyl perbenzoate, dicumyl peroxide, benzoyl peroxide, di-t-butyl peroxide, or mixtures thereof. This technique is described, for example, in U.S. Pat. No. 4,317,765 and in Japanese Patent Application 62/58774.

Said coupling agent may also be used as a coating material for said inert compound (c). The quantity of coupling agent to be added to the composition depends mainly on the type of coupling agent used and on the quantity of inert compound (c) added, and is generally between 0.05 part in volume and 10 part in volume, preferably between 0.1 part in volume and 5 part in volume, with respect to the total volume of the composition.

According to another preferred embodiment, the inert compound (c) may be selected from inorganic oxide glasses selected from silicate oxide glasses having the following mole percent composition: more than 70% SiO₂, 0% to 5% B₂O₃, 0% to 5% Pb₂O₃, 0% to 20% of at least one oxide selected from the oxide of: Mg, Sr, Ba, Li, P, Na, K, Al, Zr, Mo, W, Nb.

The inert compound (c) may be added to the composition acccording to the present invention in a quantity of between 5 parts in volume to 90 parts in volume, preferably between 10 part in volume to 60 parts in volume, with respect to the total volume of the composition.

Other conventional components may be added to the composition according to the present invention, for example antioxidants, processing aids, lubricants, pigments, foaming agent, plasticizers, UV stabilizers, flame-retardants, thermal stabilizers, or mixtures thereof.

Conventional antioxidants suitable for the purpose may be selected from antioxidants of aminic or phenolic type such as, for example: polymerized trimethyl-dihydroquinoline (for example poly-2,2,4-trimethyl-1,2-dihydro-quinoline); 4,4′-thiobis-(3-methyl-6-tert-butyl)-phenol; pentaerythryl-tetra-[3-(3,5-ditert-butyl-4-hydroxyphenyl)propionate]; 2,2′-thiodiethylene-bis-[3-(3,5-ditert-butyl-4-hydroxyphenyl)-propionate], or the mixtures thereof.

Processing aids usually added to the composition according to the present invention are, for example, calcium stearate, zinc stearate, stearic acid, paraffin wax, silicone rubbers, silicone oil, and the like, or the mixtures thereof.

The composition according to the present invention may be either cross-linked or not cross-linked according to the required countries specifications.

If cross-linking is carried out, the composition comprises also a cross-linking system, of the peroxide or silane type, for example. It is preferable to use a silane-based cross-linking system, using peroxides as grafting agents. Examples of organic peroxides that may be advantageously used, both as cross-linking agents or as grafting agents for the silanes, are dicumyl peroxide, t-butyl cumyl peroxide, 2,5-dimethyl-2,5-di(t-butyl peroxy)hexane, di-t-butyl peroxide, t-butylperoxy-3,3,5-trimethylhexanoate, ethyl-3,3-di(t-butylperoxy)butyrrate. Examples of silanes that may be adevantageously used are (C₁-C₄)-alkyloxyvinylsilanes such as, for example, vinyldimethoxysilane, vinyltriethoxysilane, vinyldimethoxyethoxysilane.

The cross-linking system may also comprises a cross-linking catalyst selected from those known in the art. In the case of cross-linking with silanes, for example, lead dibutyl dilaurate may be advantageously used.

The composition according to the present invention may be either foamed or not foamed.

If foaming is carried out, the organic polymer (a) is usually foamed during the extrusion phase. Said foaming may be carried out either chemically by means of addition of a suitable foaming agent, that is to say one which is capable of generating a gas under defined temperature and pressure conditions, or physically, by means of injection of gas at high pressure directly into the extrusion cylinder.

Examples of suitable foaming agent are: azodicarboamide, mixtures of organic acids (for example, citric acid) with carbonates and/or bicarbonates (for example, sodium bicarbonates).

Examples of gases to be injected at high pressure into the extrusion cylinder are: nitrogen, carbon dioxide, air, low-boiling hydrocarbons such as, for example, propane or butane.

The composition according to the present invention may be prepared by mixing the polymer components with the other components according to techniques knows in the art. The mixing may be carried out, for example, by an internal mixer of the tangential (Banbury) or co-penetrating rotor type, or with interpenetrating rotors, or by continuous mixers of the Ko-Kneader (Buss) type or of the co-rotating or counter-rotating double-screw type.

The composition according to the present invention may be used to directly coat a conductor, or to make a an external layer on the conductor previously coated with at least an insulating layer. The coating step may be carried out, for example, by extrusion. In case at least two layers are present, the extrusion may be carried out in several separate steps, for example, by extruding, in a first step, the internal layer on the conductor and, in a second step, the external layer on the internal one. Advantageously, the coating process may be made in one step, for example, by “tandem” technique, wherein different single extruders, arranged in series, are used, or by co-extrusion with a single multiple extruding head.

Without being bound in any way to any interpretative theory, the Applicant believes that, in the event of fire, the composition according to the present invention is able to form a solid char structure which endows a cable with fire resistant properties.

During the combustion of the organic polymer (a) the glass fit (b) starts to flows and, as disclosed above, reaches a viscosity of between 10⁷ poise and 10⁸ poise. Said relatively low viscosity causes the glass frit (b) to flow over the burning organic polymer (a), so that the burning or burnt organic polymer (a) and the inert compound (c) are encapsulated by the flowing of the glass frit (b): as a result of such encapsulation, a stable char structure is provided, capable of further resisting to the fire and to maintains the insulation properties required.

### BRIEF DESCRIPTION OF THE DRAWINGS

Further details will be illustrated in the following, appended drawings, in which:

FIG. 1 shows, in cross section, an electric cable of the unipolar type according to one embodiment of the present invention;

FIG. 2 shows, in cross section, an electric cable of the unipolar type according to another embodiment of the present invention;

FIG. 3 shows, in cross section, an electric cable of the tripolar type according to a further embodiment of the present invention;

FIG. 4 shows, in perspective view, a length of cable with parts removed in stages, to reveal its structure.

### DETAILED DESCRIPTION OF THE INVENTION

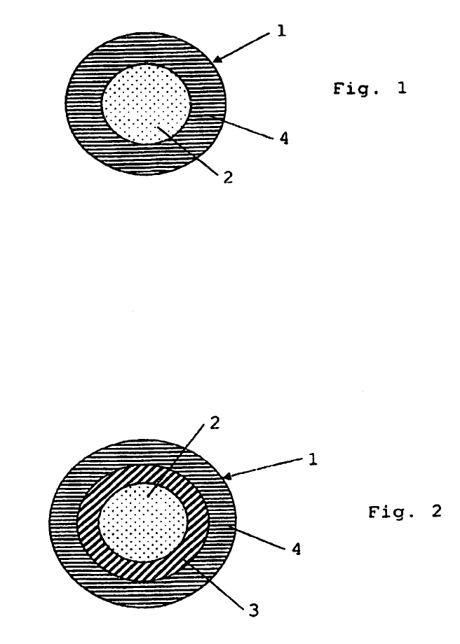

Referring to FIG. 1, cable 1 comprises a conductor 2 coated directly by an external layer 4 that comprise the composition according to the present invention. In this case, if the conductor 2 is metallic, the external layer 4 also acts as electric insulation.

Referring to FIG. 2, cable 1 comprises a conductor 2, an internal insulating coating layer 3 and an external layer 4. The internal insulating coating layer 3 or the external layer 4 may comprise the composition according to the present invention. In the case in which the external layer 4 comprises the composition according to the present invention, the insulating coating layer 3 may comprise a crosslinked or non-crosslinked polymer composition, preferably devoid of halogen, with electrical insulating properties which is known in the art and may be selected, for example, from: polyolefins (homopolymers or copolymers of different olefins), olefin/ethylenically unsaturated ester copolymers, polyesters, polyethers, polyether/polyester copolymers and mixtures thereof. Specific examples of such polymers are: polyethylene (PE), in particular linear low-density polyethylene (LLDPE); polypropylene (PP); propylene/ethylene thermoplastic copolymers; ethylene-propylene rubbers (EPR) or ethylene-propylene-diene rubbers (EPDM); natural rubbers; butyl rubbers; ethylene/vinyl acetate copolymers (EVA); ethylene/methyl acrylate copolymers (EMA); ethylene/ethyl acrylate copolymers (EEA); ethylene/butyl acrylate copolymers (EBA); ethylene/α-olefin copolymers. It is also possible to use the same material for the insulating coating layer 3 as for the external layer 4. Alternatively, the insulating coating layer 3 may be a fire resistant coating layer comprising silicone polymer or mica tape as disclosed in the prior art as the external layer 4 comprises the composition according to the present invention.

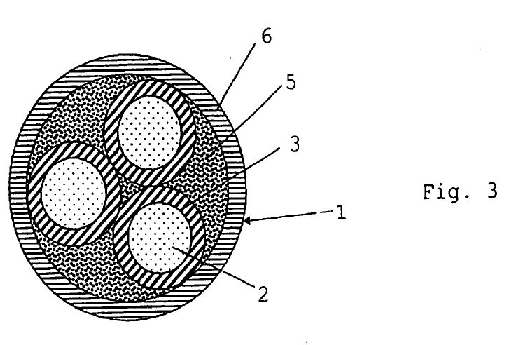

Referring to FIG. 3, cable 1 comprises three conductors 2, each one covered by an insulating coating layer 3 that may comprise the composition according to the present invention. The conductors 2 thus insulated are wound around one another and the interstices between the insulated conductors 2 are filled with a filler material that forms a continuous structure having a substantially cylindrical shape. The filler material 5 is preferably a flame-retarding material. An outer sheath 6, which may comprise the composition according to the present invention, is applied, generally by extrusion, to the structure thus obtained. Alternatively, said outer sheath 6, may consists of a thermoplastic material, for example, uncrosslinked polyethylene (PE), a homopolymer or copolymer of propylene, or a polymeric material as described in patent applications EP 893 801 or EP 893 802.

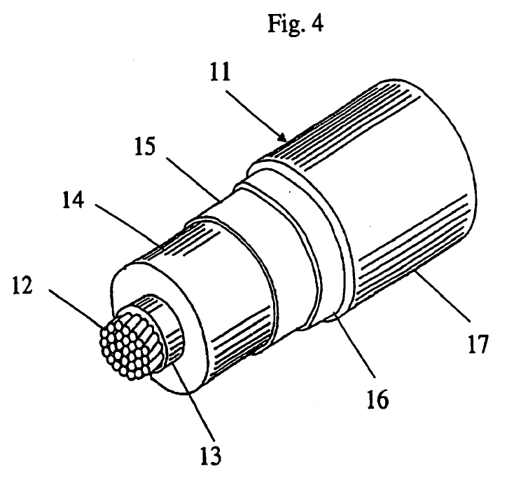

Referring to FIG. 4, cable 11 comprises, in order from the centre outwards: a conductor 12, an internal semiconducting layer 13, an insulating coating layer 14, an external semiconducting layer 15, a metallic screen 16, and an outer sheath 17.

The conductor 12 generally consists of metal wires, preferably of copper or aluminium, stranded together according to conventional techniques. The internal and external semiconducting layers 13 and 15 are extruded on the conductor 12, separately or simultaneously with the insulating coating layer 14 which may comprise the composition according to the present invention. A screen 16, generally consisting of electrically conducting wires or tapes, wound spirally, is usually arranged around the external semiconducting layer 15. Said screen is then covered with a sheath 17, consisting of a thermoplastic material, for example uncrosslinked polyethylene (PE), a homopolymer or copolymer of propylene, or a polymeric material as described in patent applications EP 893 801 or EP 893 802, or the composition according to the present invention.

The cable may in addition be provided with an outer protective structure (not shown in FIG. 4), which mainly performs the function of mechanical protection of the cable against impact and/or compression. Said protective structure may be, for example, a metallic armour or a layer of expanded polymeric material as described in patent application WO 98/52197.

FIGS. 1, 2, 3 and 4 show just some possible embodiments of a cable according to the present invention.

Although the present description mainly focuses on the production of cables for the transmission or distribution of low- or medium-voltage power, the composition described above may be used for coating electric devices in general, and in particular various types of cables, for example high-voltage cables or cables for telecommunications, or alternatively for data transmission, as well as for mixed power/telecommunication cables. Moreover, the composition according to the present invention may be used, for example, as floor covering, as a vertical fire barrier (whether alone or as part of low-weight composite), as glazing beads for fire doors and in printed circuit board.

The present invention is further described in the following examples, which are merely for illustration and must not be regarded in any way as limiting the invention.

### Examples 1-6

### Preparation of the Compositions

The composition given in Table 1 (the amounts of the various components are expressed in parts in volume) were prepared by inserting the various ingredients in a Banbury internal mixer of 1.2 l volume. After bringing the temperature to 160° C. and subsequent cooling, the mixer was emptied and the so obtained compositions were divided in small cubes having 3 mm diameter.

Flame Resistance Test Small cables were then prepared by extruding said composition onto a single red copper wire with a cross-section of 1.5 mm², so as to obtain a 0.7 mm thick fire resistant layer. The extrusion was carried out by means of a 45 mm single-screw extruder in 25 D configuration, with rotary speed of about 45 rev/min. The speed line was about 20 m/min, with temperature in the various zones of the extruder of 100° C.-110° C.-120° C.-130° C., the temperature of the extrusion neck was 135° C. and that of the die was 140° C.

The cables were subjected to the flame resistant test according to IEC standard 60.332-1, which consists in subjecting a sample of the cable 60 cm long, placed vertically, to the direct action of a Bunsen burner flame applied for 1 hour and 30 minutes at an inclination of 45° C. relative to the samples. The obtained results are reported in Table 1.

TABLE 1

| COMPOUNDS | EXAMPLE 1 (*) | EXAMPLE 2 | EXAMPLE 3 | EXAMPLE 4 | EXAMPLE 5 | EXAMPLE 6 |
|---|---|---|---|---|---|---|
| Elvax ® 40L03 | 40 | 50 | 50 | 50 | 50 | 50 |
| Ceepree C200M | 10 | — | — | — | — | — |
| AG2868 | — | 10 | 10 | 10 | 10 | 10 |
| Translink ® 37s | — | 40 | — | 20 | 20 | 20 |
| Mistrobond ® | — | — | 40 | 20 | 20 | 20 |
| Dynasylan ® AMEO | 1 | 0.5 | 0.5 | 0.5 | 0.5 | 0.5 |
| Retic ® DCP | — | — | — | — | — | 0.95 |
| 47 V1000 | 2 | — | — | — | 2.3 | 2.3 |
| Martinal ® Ol 104 | 40 | — | — | — | — | — |
| IEC 60332-1 | flowing | compact | compact | compact | compact | compact |
| | | char | char | char | char | char |

(*): comparative.
Elvax ® 40L03 (DuPont): ethylene-vinyl acetate copolymer containing 40 wt. % vinyl acetate; T₁ = 260° C.; T₂ = 400° C.;
Ceepree C200M (Ceepre Product Ltd): mixtures of frits - melting point range 350° C.-900° C.;
AG2868: inorganic oxide glass having softening point of 450° C.;
Translink ® 37s (Engelhard): silanized calcined kaolin;
Mistrobond ® (Luzenac): silanized talc;
Dynasylan ® AMEO (Sivento-Chemie): 3-aminopropyl-triethoxysilane;
Retic ® DCP (Oxido): dicumyl peroxide;
47 V1000 (Rhodia Chemie): silicon oil;
Martinal 01 104 (Martinswerke): aluminium hydroxide.

The data given in Table 1 clearly show that the cable insulated with a coating layer made from the composition of Example 1 wherein a commercial product Ceepree was used is not endowed with sufficient fire resistance properties. As a matter of fact, no char forming occurred and the coating layer flows during the flame resistant test.

### Example 7

A tripolar low voltage cable was manufactured in accordance with the embodiment of FIG. 3.

Each of the three conductors 2 of said cable is constituted by a red copper wire with a cross-section of 1.5 mm² and was coated with an insulating coating layer 3 made of the composition of Example 6 so as to obtain a thickness of 1.0 mm. Said conductor 2 thus insulated are wound around one another by using a combining machine and the interstices between the insulated conductor are filled with 85% magnesium hydroxide filled high density polyethylene. Another sheat 6 made of 70% magnesium hydroxide filled high density polyethylene was applied by extrusion.

The tripolar cable so obtained was subjected to the fire resistant test according to IECF 60331 which consists in subjecting a sample of the cable 120 cm long, one extremity of which has been connected with an electric circuit, placed orizontally, to the direct action of a burner flame at a temperature of 750° C. and to its rated voltage for 90 minutes: during said treatment short circuit has not occurred.

1-41. (canceled)

42. A cable comprising at least one conductor and at least a fire resistant coating layer including a composition comprising:
(a) at least an organic polymer having a combustion temperature range between a minimum value T₁ and a maximum value T₂;
(b) at least a glass frit; and
(c) at least an inert compound chosen from aluminum silicates and magnesium silicates;
wherein:
said inert compound (c) has a softening point or a melting temperature of not less than 1000° C.;
said glass frit (b) reaches a viscosity of between 10⁷ poise and 10⁸ poise in a selected temperature range including the combustion temperature range of said organic polymer (a), said selected temperature range being such that said glass frit (b) flows over said inert compound (c) and burns organic polymer (a) so as to form a solid char fire resistant coating layer.

43. A cable comprising at least one conductor and at least a fire resistant coating layer including a composition comprising:
(a) at least an organic polymer having a combustion temperature range between a minimum value T₁ and a maximum value T₂;
(b) at least a glass frit; and
(c) at least an inert compound chosen from aluminum silicates and magnesium silicates;
wherein:
said inert compound (c) has a softening point or a melting temperature of not less than 1000° C.; and
said glass frit (b) reaches a viscosity of between 10⁷ poise and 10⁸ poise in a temperature range between T₁−100° C. and T₂+100° C.

44. The cable according to claim 42, wherein said glass frit (b) reaches a viscosity of between about 10⁷ poise and 10⁸ poise at a temperature higher than about 250° C.

45. The cable according to claim 44, wherein said glass frit (b) reaches a viscosity of between 10⁷ poise and 10⁸ poise in a temperature range between about 250° C. and about 450° C.

46. The cable according to claim 42 or 43, wherein the fire resistant coating layer is placed directly in contact with the conductor.

47. The cable according to claim 42 or 43, further comprising an electrically insulating inner layer wherein the fire resistant coating layer is placed radially external to said electrically insulating inner layer.

48. The cable according to claim 47, wherein the fire resistant coating layer is placed directly in contact with said electrically insulating inner layer.

49. The cable according to claim 47, wherein the fire resistant coating layer placed radially external to said electrically insulating inner layer is the outermost layer of the cable.

50. The cable according to claim 42 or 43, wherein the organic polymer (a) is selected from polyolefins, copolymers of different olefins, copolymers of olefins with esters having at least one ethylene unsaturation, polyesters, polyethers, copolymers of polyether/polyester, and mixtures thereof.

51. The cable according to claim 50, wherein the organic polymer (a) is selected from high density polyethylene, medium density polyethylene, low density polyethylene, copolymers of ethylene with α-olefins having 3 to 12 carbon atoms, polypropylene, thermoplastic copolymers of propylene with another olefin, copolymers of ethylene with at least an ester selected from alkylacrylates, alkylmethacrylates and vinylcarboxylates, wherein the alkyl group, whether linear or branched, has from 1 to 8 carbon atoms, wherein the carboxyl group, whether linear or branched, has from 2 to 8 carbon atoms, elastomeric copolymers of ethylene/α-olefins, halogenated polymers, and mixtures thereof.

52. The cable according to claim 51, wherein the organic polymer (a) is an ethylene/vinyl acetate copolymer.

53. The cable according to claim 42 or 43, wherein the organic polymer (a) is selected from copolymers of ethylene with at least one aliphatic α-olefin, and optionally a polyene, said copolymers having a molecular weight distribution (MDW) index of less than 5.

54. The cable according to claim 53, wherein said copolymers of ethylene with at least one aliphatic α-olefin has a melting enthalpy (ΔHₘ) of not less than 30 J/g.

55. The cable according to claim 53, wherein the aliphatic α-olefin, is an olefin of formula CH₂═CH—R, in which R represents a linear or branched alkyl group containing from 1 to 12 carbon atoms.

56. The cable according to claim 50, wherein the organic polymer (a) contains functional groups selected from: carboxylic groups, anhydride groups, ester groups, silane groups, and epoxy groups.

57. The cable according to claim 53, wherein the organic polymer (a) contains functional groups selected from: carboxylic groups, anhydride groups, ester groups, silane groups, and epoxy groups.

58. The cable according to claim 42 or 43, wherein the organic polymer (a) is selected from thermosetting resins.

59. The cable according to claim 58, wherein the thermosetting resins are selected from epoxy acrylates, polyurethane acrylates, acrylated polyesters, phenolic resins, and mixtures thereof.

60. The cable according to claim 42 or 43, wherein the glass frit (b) is selected from inorganic oxide glasses.

61. The cable according to claim 60, wherein the inorganic oxide glasses are selected from phosphate glasses having the following mole percent composition: 1.2% to 3.5% of B₂O₃, 50% to 75% of P₂O₅, 0% to 30% of PbO and 0% to 5% of at least one oxide selected from the oxide of Cu, Ag, Au, Sc, Y, La, Ti, Zr, Hf, V, Nb, Ta, Cr, Mo, W, Mn, Tc, Re, Fe, Co, Ni, Ru, Rh, Pd, Os, Ir, Pt, Ce, Pr, Nd, Pm, Sm, Eu, Gd, Tb, Dy, Ho, Er, Tm, Yb, Lu, Th, Pd, and U, which glass includes at least one oxide selected from alkali metal oxides and at least one oxide selected from alkaline earth metal oxides and zinc oxide.

62. The cable according to claim 60, wherein the inorganic oxide glasses are selected from lead oxide glasses having the following mole percent composition: 1.2% to 3.5% of B₂O₃, 50% to 58% of P₂O₅, 10% to 30% of PbO and 0% to 5% of at least one oxide selected from the oxide of Cu, Ag, Au, Sc, Y, La, Ti, Zr, Hf, V, Nb, Ta, Cr, Mo, W, Mn, Tc, Re, Fe, Co, Ni, Ru, Rh, Pd, Os, Ir, Pt, Ce, Pr, Nd, Pm, Sm, Eu, Gd, Tb, Dy, Ho, Er, Tm, Yb, Lu, Th, Pd, and U, which glass includes at least one oxide selected from alkali metal oxides and at least one oxide selected from alkaline earth metal oxides and zinc oxide.

63. The cable according to claim 60, wherein the inorganic oxide glasses are selected from bismuth oxide glasses having he following mole percent composition: 1.2% to 20% of B₂O₃, 50% to 75% of Bi₂O₃, 10% to 30% of ZnO, and 0% to 5% of at least one oxide selected from the oxide of Pb, Fe, Si, Cu, Ag, Au, Sc, Y, La, Ti, Zr, Hf, V, Nb, Ta, Cr, Mo, W, Mn, Tc, Re, Fe, Co, Ni, Ru, Rh, Pd, Os, Ir, Pt, Ce, Pr, Nd, Pm, Sm, Eu, Gd, Tb, Dy, Ho, Er, Tm, Yb, Lu, Th, Pd, and U, which glass includes at least one oxide selected from alkali metal oxides and at least one oxide selected from alkaline earth metal oxides.

64. The cable according to claim 60, wherein the inorganic oxide glasses are selected from borate oxide glasses having the following mole percent composition: 15% to 35% CaO, 35% to 55% B₂O₃, 10% to 35% SiO₂, 0% to 20% of at least one oxide selected from the oxide of Mg, Sr, Ba, Li, P, Na, K, Al, Zr, Mo, W, Nb, and 0% to 8% of F.

65. The cable according to claim 42 or 43, wherein the glass frit (b) is added to the composition in a quantity of between 1 part in volume to 50 parts in volume, with respect to the total volume of the composition.

66. The cable according to claim 65, wherein the glass frit (b) is added to the composition in a quantity of between 2 parts in volume to 25 parts in volume with respect to the total volume of the composition.

67. The cable according to claim 42 or 43, wherein the inert compound (c) is added to the composition in a quantity of between 5 parts by volume to 90 parts by volume with respect to the total volume of the composition.

68. The cable according to claim 67, wherein the inert compound (c) is added to the composition in a quantity of between 10 parts by volume to 60 parts by volume with respect to the total volume of the composition.

69. A composition comprising:
(a) at least an organic polymer having a combustion temperature range between a minimum value T₁ and a maximum value T₂;
(b) at least a glass frit;
(c) at least an inert compound chosen from aluminum silicates and magnesium silicates;
wherein:
said inert compound (c) has a softening point or a melting temperature of not less than 1000° C.; and
said glass frit (b) reaches a viscosity of between 10⁷ poise and 10⁸ poise in a temperature range between T₁−100° C. and T₂+100° C.

70. The composition according to claim 69, wherein the glass frit (b) reaches a viscosity of between 10⁷ poise and 10⁸ poise at a temperature higher than 250° C.

71. The composition according to claim 70, wherein said glass frit (b) reaches a viscosity of between 10⁷ poise and 10⁸ poise in a temperature range between about 250° C. and about 450° C.

72. The composition according to claim 69, wherein the organic polymer (a) is selected from polyolefins, copolymers of different olefins, copolymers of olefins with esters having at least one ethylene unsaturation, polyesters, polyethers, copolymers of polyether/polyester, and mixtures thereof.

73. The composition according to claim 69, wherein the organic polymer (a) is selected from copolymers of ethylene with at least one aliphatic α-olefin, and optionally a polyene, said copolymers having a molecular weight distribution (MDW) index of less than 5.

74. The composition according to claim 72 or 73, wherein the organic polymer (a) contains functional groups selected from: carboxylic groups, anhydride groups, ester groups, silane groups, and epoxy groups.

75. The composition according to claim 69, wherein the organic polymer (a) is selected from thermosetting resins.

76. The composition according to claim 69, wherein the glass frit (b) is selected from inorganic oxide glasses.

77. The composition according to claim 69, wherein the glass frit (b) is added to the composition in a quantity of between 1 part by volume to 50 parts by volume, with respect to the total volume of the composition.

78. The composition according to claim 69, wherein the inert compound (c) is added to the composition in a quantity of between 5 parts by volume to 90 parts by volume with respect to the total volume of the composition.

79. A method for preserving insulation capability in a cable under fire conditions which comprises forming a solid char structure by causing at least a glass frit (b) to flow over at least an inert compound (c) chosen from aluminum silicates and magnesium silicates and at least a burned organic polymer (a).

80. The method according to claim 79, wherein causing at least a glass frit (b) to flow, includes selecting a glass frit (b) which is able to reach a viscosity of between 10⁷ poise and 10⁸ poise at a temperature in a range of temperatures which includes the combustion temperature range of the organic polymer (a).

81. The method according to claim 79, wherein the organic polymer (a) is selected from polyolefins, copolymers of different olefins, copolymers of olefins with esters having at least one ethylene unsaturation, polyesters, polyethers, copolymers of polyether/polyester, and mixtures thereof.

82. The method according to claim 79, wherein the organic polymer (a) is selected from copolymers of ethylene with at least one aliphatic α-olefin, and optionally a polyene, said copolymers having a molecular weight distribution (MDW) index of less than 5.

83. The method according to claim 81 or 82, wherein the organic polymer (a) contains functional groups selected from carboxylic groups, anhydride groups, ester groups, silane groups, and epoxy groups.

84. The method according to claim 79, wherein the organic polymer (a) is selected from thermosetting resins.

85. The method according to claim 79, wherein the glass frit (b) is selected from inorganic oxide glasses.

86. The method according to claim 79, wherein the glass frit (b) is added to the composition in a quantity of between 1 part by volume to 50 parts by volume, with respect to the total volume of the composition.

87. The method according to claim 79, wherein the inert compound (c) is added to the composition in a quantity of between 5 parts by volume to 90 parts by volume with respect to the total volume of the composition.
